(19) United States
(12) Patent Application Publication
(10) Pub. No.: US 2009/0169317 A1
(43) Pub. Date: Jul. 2, 2009

(54) Hole Saw Holder

(76) Inventor: Scott William Rae, Cumbernauld (GB)

Correspondence Address: NIXON & VANDERHYE, PC, 901 NORTH GLEBE ROAD, 11TH FLOOR, ARLINGTON, VA, 22203, US

(21) Appl. No.: 12/083,676

(22) PCT Filed: Oct. 24, 2006
(86) PCT No.: PCT/GB2006/003924

§ 371 Date: Apr. 17, 2008

(30) Foreign Application Priority Data
Oct. 25, 2005 (GB) 0521697.3

(51) Int. Cl. B27B 5/12

(52) U.S. Cl. 408/204

(57) ABSTRACT

A hole saw holder comprising an elongate body having a first end and a second end, wherein the first end has an external thread (6) of sufficient length t receive a plurality of hole saws (16), a support formation (8) at the end of the external thread for supporting one or more hole saws received by the external thread, and a central axial drill bit receiving bore (4) which extends throughout the length of the elongate body. The hole saw holder can used to conveniently store a plurality of hole saws and a hole saw arbour. T hole saw holder can be used with two hole saws of different diameters to enlarge a hole which has already been drilled in a surface.

### FIELD OF THE INVENTION

The invention relates to hole saws, holders for hole saws, and kits including hole saws or holders for hole saws.

### BACKGROUND TO THE INVENTION

Hole saws are in common use to drill circular holes of predetermined diameter. Hole saws are generally tubular having a first open circular end with serrated cutting edges and a second circular end closed by a flat base plate having a central circular internally threaded opening enabling the hole saw to be screwed onto an arbour which can itself be mounted onto a drill in use, enabling the hole saw to be rotated at speed by a drill, thereby cutting a hole. Hole saws often include holes in the flat base plate for receiving enlargeable locking pins from an arbour and/or holes in the tubular outer walls which enable material trapped within the hole saw during the drilling process to be removed.

At the present time, hole saws are generally sold individually or in kits, packaged in tool boxes. Tool boxes are bulky and can readily fall apart. Some embodiments of the present invention aim to provide improved apparatus for storing hole saws.

Hole saws are generally used in combination with an arbour which holds a drill bit that functions as a pilot drill and serves to locate the hole saw and thus the resulting circular hole. It is known to use a smaller diameter hole saw instead of a solid drill bit as a pilot drill. For example, the L. S. Starrett Company of Athol, Mass., sell an “Oops Arbor” which comprises an adaptor which has at one end an external thread for retaining a hole saw, and at the other end a pin which fits into the drill bit retaining bore of an arbour. In use, a larger diameter hole saw can be fitted to a conventional arbour, a smaller diameter hole saw can be fitted to the external thread of the adaptor, and the adaptor pin can be inserted into the drill bit retaining bore of the arbour. The smaller and large diameter hole saws are thus held in a concentric and coaxial relationship. The smaller diameter hole saw can be aligned with a hole which has already been drilled, which ensures that the hole drilled by the larger hole saw is concentric with the smaller hole. The adaptor is of use where a hole which is too small has been accidentally drilled and so there is no surface into which a conventional solid pilot drill can be inserted to locate a subsequent larger hole. A disadvantage of this arrangement is that it can take some time to configure. As the adaptor has no other function, it can be misplaced.

Some aspects of the invention aim to provide alternative apparatus for supporting two hole saws on an arbour in a coaxial and concentric arrangement so that the inner hole saw can be used to guide the drilling of a larger hole by the outer hole saw.

### SUMMARY OF THE INVENTION

According to a first aspect of the present invention there is provided a hole saw holder comprising an elongate body having a first end and a second end, wherein the first end has an external thread of sufficient length to receive a plurality of hole saws, a support formation at the end of the external thread for supporting one or more hole saws received by the external thread, and a central axial drill bit receiving bore which extends throughout the length of the elongate body.

The external thread of the hole saw holder may be of sufficient length to receive three or more hole saws. Preferably, the external thread of the hole saw holder is of sufficient length to receive four or more hole saws. Typically, the external thread of the hole saw holder is at least 1 cm long.

The support formation functions to prevent the hole saws from sliding off the external thread and also to support the hole saws during drilling in embodiments in which the hole saw holder is used to support hole saws during drilling. The support formation preferably comprises a shoulder, such as a generally cylindrical shoulder, which is broader than the external thread.

Thus, the hole saw holder may be used to hold a plurality of hole saws on the external thread portion in a concentric coaxial arrangement by threading the internally threaded holes in the flat base plates of hole saws onto the external thread portion, with the largest diameter hole saw fitted first. An arbour having a pilot drill bit fitted therein can be conveniently stored with the hole saw holder in a space saving fashion, with the pilot drill bit extending into (typically through) the drill bit receiving bore.

Preferably, the second end of the elongate body comprise a coupling formation for coupling the hole saw holder to an arbour. The coupling formation typically enables the arbour to be coupled to the elongate body in a coaxial arrangement such that a drill bit retained by the arbour extends into (typically through) the drill bit receiving bore.

Preferably, the coupling formation is configured to enable the hole saw holder to be coupled to an arbour in a coaxial torque transmitting arrangement. Thus, the hole saw holder can be coupled to an arbour which is itself coupled to a drill. This enables a user to drill a hole with the hole saw holder mounted on a drill. This arrangement could be employed to drill a hole using a first hole saw mounted on the external threaded portion with a second, smaller diameter, hole saw mounted on the external threaded portion after the first hole saw, functioning to locate the first hole saw.

Preferably, the coupling formation comprises an internally threaded portion of the bore at the second end of the elongate body, which is operable to receive an externally threaded portion of a hole saw arbour.

Typically, the internally threaded portion of the bore has the same major diameter as the externally threaded portion of the elongate body. That is to say, the externally threaded portion of the elongate body preferably has the same major diameter as the externally threaded portion of a hole saw arbour which can be threaded into and received by the internally threaded portion of the bore. Thus, the hole saw holder can preferably be used with hole saws which would fit onto the arbour.

The elongate body may comprise tool engaging formations for engaging with a torsion applying tool. For example, the outside edge of a portion of the elongate body may be generally circular with one or more tool engaging formations in the form of indentations or flattened portions, or may be generally square or hexagonal. Thus, a tool can be applied to the tool engaging formation to apply a torsional force to remove the elongate body from an arbour in embodiments where the elongate body includes an arbour receiving formation, discussed below. The tool engaging formation may be part of the shoulder and, preferably, the elongate body comprises a shoulder which extends from the end of the external thread to the second end of the elongate body and which comprises one or more tool engaging formations.

The second end of the elongate body may have an end face which includes one or more holes or slots for receiving an engageable pin or other retaining member of an arbour that is coupled to the coupling formation and which has such pins or other retaining members for retaining hole saws on the arbour.

The invention extends in a second aspect to a kit comprising (i) a hole saw holder comprising an elongate body having a first end and a second end, wherein the first end has an external thread of sufficient length to receive a plurality of hole saws, and a support formation at the end of the external thread for supporting one or more hole saws received by the external thread, and (ii) a hole saw having a base plate with a central internally threaded hole therein, wherein the internally threaded hole in the base plate is suitable for threading onto the external thread of the hole saw holder.

Preferably, the kit comprises a plurality of said hole saws of different diameters.

The hole saw holder may have a central axial drill bit receiving bore which extends throughout the length of the elongate body. The hole saw holder is preferably a hole saw holder according to the first aspect of the present invention.

The kit may further comprise an arbour having a first end and a second end, wherein the first end comprises a drill bit retaining member with an external thread for receiving a hole saw and the second end comprises a formation (such as a shank) for attachment to a drill chuck, wherein the dimensions of the external thread of the arbour are such that the arbour can be threaded into the internally threaded portion of the bore of the hole saw holder. Preferably, the external thread of the arbour and the external thread of the hole saw holder have the same major diameter, pitch, depth of thread and handedness. The length of the external thread of the hole saw holder will typically be at least twice, and preferably four times, the length of external thread of the arbour.

The kit may further comprise a pilot drill bit, the length of which is selected such that, when the pilot drill bit is fitted into the drill bit retaining member, the hole saw holder is screwed onto the external thread of the arbour, and a hole saw is screwed onto the external thread of the hole saw holder, the pilot drill bit extends into but not beyond the hole saw.

According to a third aspect of the present invention second aspect to a kit comprising (i) a hole saw holder comprising an elongate body having a first end and a second end, wherein the first end has an external thread of sufficient length to receive a plurality of hole saws, a support formation at the end of the external thread for supporting one or more hole saws received by the external thread, a central axial drill bit receiving bore which extends throughout the length of the elongate body, and a coupling formation at the second end for coupling the hole saw holder to an arbour; and (ii) an arbour having a first end and a second end, wherein the first end comprises an drill bit retaining member with an external thread for receiving a hole saw and the second end comprises a formation for attachment to a drill chuck, wherein the dimensions of the external thread of the arbour are such that the arbour can be threaded into the internally threaded portion of the bore of the hole saw holder.

Preferably, the external thread of the arbour and the external thread of the hole saw holder have the same major diameter, pitch, thread depth and handedness. The length of the external thread of the hole saw holder will typically be at least twice, and preferably four times, the length of external thread of the arbour. Preferably, the hole saw holder is a hole saw holder according to the first aspect of the invention.

According to a fourth aspect of the present invention there is provided a method of expanding the diameter of an existing circular hole in a surface from a first diameter to a second diameter using a hole saw, comprising:
(i) fitting a first hole saw having a diameter equal to the second diameter to a hole saw holder, wherein the hole saw holder comprises an elongate body having a first end and a second end, wherein the first end has an external thread of sufficient length to receive a plurality of hole saws, and the hole saw holder further comprises a support formation at the end of the external thread for supporting one or more hole saws received by the external thread, a central axial drill bit receiving bore which extends throughout the length of the elongate body, and a coupling formation at the second end for coupling the hole saw holder to an arbour;
(ii) fitting a second hole saw having a diameter equal to the first diameter to the external thread of the hole saw holder;
(iii) coupling the hole saw holder to an arbour which is coupled to a drill such as to transmit torsion from the drill;
(iv) locating the second hole saw within the existing circular hole; and
(v) drilling a hole having the second diameter using the first hole saw.

Thus, the second hole saw functions as a pilot drill, locating the first hole saw in the correct position to ensure that the enlarged hole is concentric with the existing circular hole.

The hole saws may be threaded onto the external thread of the hole saw holder before or after the coupling of the hole saw holder to the arbour.

During the drill process, the arbour may retain a solid pilot drill which extends into (preferably through) the bore of the elongate body. Typically, the solid pilot drill will not extend beyond either hole saw.

Further optional features of the hole saw holder correspond to those discussed in relation to the first aspect of the invention.

### DESCRIPTION OF THE DRAWINGS

An example embodiment of the present invention will now be illustrated with reference to the following Figures in which:

FIG. 1 is a cross-section through a hole saw holder;

FIG. 2 is a plan view of a hole saw holder;

FIG. 3 is an end view of a hole saw holder;

FIG. 4 is a cross-section through a hole saw holder with different dimensions;

FIG. 5 is a cross-section through a hole saw holder, arbour and hole saws;

FIG. 6 is perspective view of hole saw apparatus configured for expanding a previously cut hole; and

FIG. 7 is a cross-section through hole saw apparatus of different dimensions for expanding a previously cut hole.

### DETAILED DESCRIPTION OF AN EXAMPLE EMBODIMENT

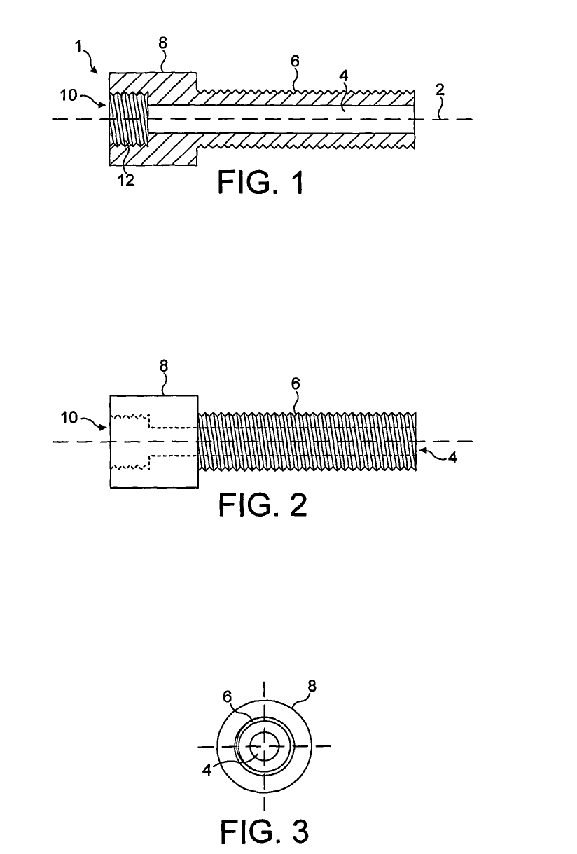

FIG. 1 is a cross-section through a hole saw holder having an elongate body shown generally as 1, with a central axis 2. The body of the hole saw holder defines an axial pilot drill bit receiving bore 4 which runs throughout the length of the holder. At a first end of the elongate body is located an external thread 6 of sufficient length to receive at least four hole saws. At a second end of the elongate body is a generally hexagonal shoulder 8 which functions as a support formation, supporting hole saws which are threaded onto the external thread. The bore of the elongate body is circular and has a uniform diameter within the externally threaded portion of the elongate body. The bore has a larger diameter portion at the second end of the elongate body, which is internally threaded 12 and suitable for receiving the externally threaded portion of a hole saw arbour.

The externally threaded portion of the elongate body and the internally threaded portion of the elongate body have the same major diameter and correspond to the same standard. That is to say, the internally threaded portion of the elongate body is adapted to receive externally threaded members which correspond in major diameter, pitch and thread depth to the externally threaded portion of the elongate body. The major diameter, pitch and thread depth of the externally threaded portion of the elongate body will have been selected to correspond with the internal threads of hole saws according to a particular thread standard. The internally threaded portion of the elongate body is designed to receive the externally threaded portion of a hole saw arbour which would also have corresponded with the internal threads of hole saws according to the same thread standard. The threads may, for example, correspond to the ½×20 UNF and ⅝×18 UNF standards.

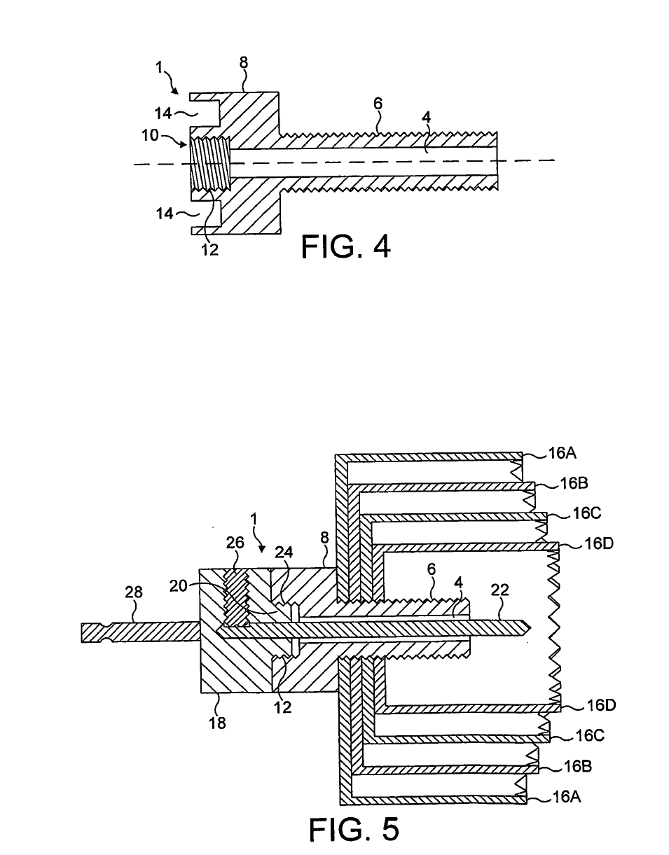

FIGS. 2 and 3 are plan and end views respectively of the same hole saw holder. FIG. 4 is a cross-section through a hole saw holder with different dimensions which further includes recesses 14 for engagement by the locking pins of a suitable arbour.

The hole saw holder can be used as a convenient storage device for hole saws and a hole saw arbour. FIG. 5 is a cross-section through a hole saw holder 1, hole saws 16A, 16B, 16C and 16D, and a hole saw arbour 18. Four hole saws are threaded onto the external thread of the hole saw holder. The largest diameter hole saw can be screwed as far as the shoulder. Further hole saws are subsequently screwed onto the external thread in order of decreasing diameter. A hole saw arbour 18 includes a drill bit retaining portion 20 which retains a drill bit 22. The drill bit retaining portion has an external thread 24 which is designed to retain a hole saw during drilling but is not of sufficient length to fully receive and retain two hole saws. The arbour further comprises a conventional screw 26 for engageably retaining the drill bit and a shank 28 which can be gripped by a drill chuck.

This is a convenient arrangement for storing hole saws and a hole saw arbour. In order to use the hole saws for conventional drilling, the hole saws and hole saw arbour are unscrewed from the hole saw holder and the hole saw arbour and a hole saw can be fitted to a drill. The hole saws which are not used can be retained on the hole saw holder.

A hanging member may be provided enabling the apparatus to be hung from a hook. For example, a string, wire or other elongate strand may be looped around the arbour to enable the device to be sold or stored hanging from a hook.

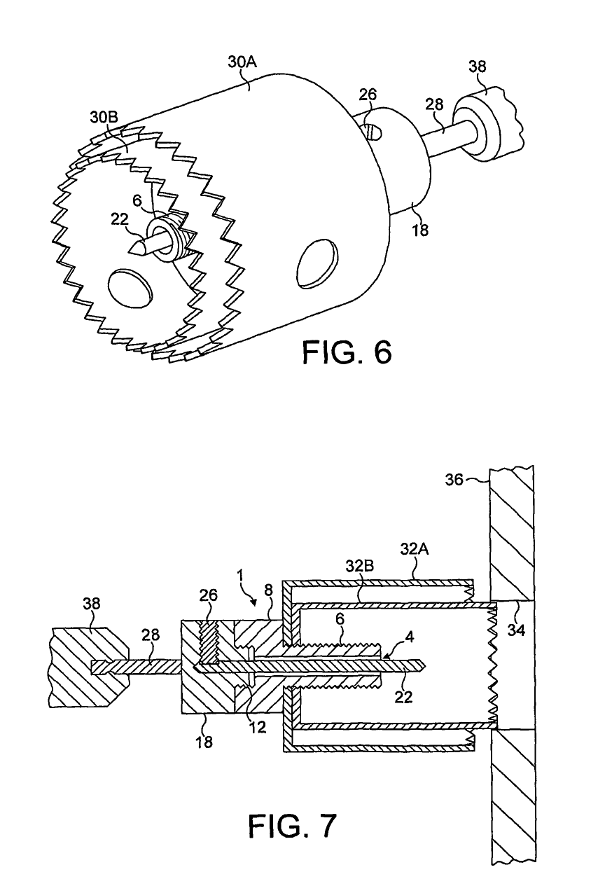

The apparatus may also be used to enlarge a hole which has already been cut in a surface. FIG. 6 is perspective view of the hole saw apparatus configured for expanding a previously cut hole. FIG. 7 is a cross-section through hole saw apparatus of different dimensions configured for expanding a previously cut hole. The hole saw arbour remains screwed into the larger diameter portion of the interior bore of the hole saw holder. A first hole saw 30A, 32A with a diameter equal to the diameter of the desired enlarged hole is screwed first onto the external thread of the hole saw holder, followed by a second hole saw 30B, 32B with a narrower diameter equal to the diameter of the hole 34 which already exists in a surface 36 which is to be cut. The first hole saw is screwed down until it rests against and is supported by the shoulder 8. The second hole saw is screwed down until it rests against the first hole saw. The arbour is then inserted into a drill chuck 38. The second hole saw is then aligned with the hole which already exists, the drill is engaged, which rotates the arbour, the hole saw holder and the first and second hole saws, and the first hole saw cuts a circle in the surface which is concentric with and larger than the hole which already exists. Although the pilot drill retained in the arbour has no specific function during this drilling procedure, it can be left in place provided that it does not extend beyond the rim of the second hole saw, which reduces the risk of losing the pilot drill.

Thus, the hole saw holder can be dual function, usable not just for storing hole saws and a hole saw arbour, but also for expanding a previously cut hole. Because of this dual function, the hole saw holder may be less likely to be misplaced than known adaptors for enabling an arbour to support two hole saws and enlarge a hole. The hole saw holder will typically be sold in kits along with a hole saw arbour and/or a plurality of hole saws of different diameters. Typically, the various parts will be fitted together to demonstrate how the hole saw holder can be used to conveniently store a hole saw arbour and/or a plurality of holes saws.

The shoulder of the hole saw holder typically includes tool engaging formations to enable it to be twisted by a tool, such as a spanner, to aid in the process of separating the hole saw holder from the arbour or hole saws. In an example embodiment, the shoulder has a generally hexagonal external surface for engaging with a spanner.

The hole saw holder is typically made from a metal, such as steel, of sufficient strength to be suitable for use during the drilling procedure. It can be readily manufactured from hex rod by forming the external thread on a lathe, drilling out the central bore and using a tap to form the internally threaded larger diameter portion of the bore. Holes or slots for receiving locking pins from a suitable equipped arbour can optionally be drilled into the face at the second end of the body of the hole saw holder.

In one example embodiment, suitable for use with hole saws of up to 32 mm diameter having internal threads which correspond to the ½×20 UNF standard, the hole saw holder is 70 mm long, the central bore has a diameter of 8 mm within the externally threaded portion, which corresponds to the ½×20 UNF standard, and the shoulder is cylindrical with an external diameter of 20 mm and length of 20 mm.

In a second example embodiment, suitable for use with hole saws of up to 32 mm diameter having internal threads which correspond to the ½×20 UNF standard, the hole saw holder is 45 mm long, the central bore has a diameter of 8 mm within the externally threaded portion, which corresponds to the ½×20 UNF standard and has a length of 30 mm, the shoulder is made from hex stock and has a breadth of 18 mm and length of 15 mm.

In a third example embodiment, suitable for use with hole saws of at least 32 mm diameter having internal threads which correspond to the ⅝×18 UNF standard, the hole saw holder is 70 mm long, the central bore has a diameter of 8 mm within the externally threaded portion, which corresponds to the ⅝×20 UNF standard, and the shoulder is cylindrical with an external diameter of 35 mm and length of 20 mm.

In a fourth example embodiment, suitable for use with hole saws of at least 32 mm diameter having internal threads which correspond to the ⅝×18 UNF standard, the hole saw holder is 35 mm long, the central bore has a diameter of 8 mm within the externally threaded portion, which corresponds to the ⅝×20 UNF standard and has a length of 20 mm, the shoulder is made from hex stock and has a breadth of 32 mm and length of 15 mm.

Further modifications and variations may be made within the scope of the invention herein disclosed.

1.-15. (canceled)

16. A hole saw holder comprising an elongate body having a first end and a second end, wherein the first end has an external thread of sufficient length to receive a plurality of hole saws, a support formation at the end of the external thread for supporting one or more hole saws received by the external thread, and a central axial drill bit receiving bore which extends throughout the length of the elongate body.

17. A hole saw holder according to claim 16, wherein the external thread of the hole saw holder is at least 1 cm long.

18. A hole saw holder according to claim 16, wherein the second end of the elongate body comprises a coupling formation for coupling the hole saw holder to an arbour.

19. A hole saw holder according to claim 18, wherein the coupling formation comprises an internally threaded portion of the bore at the second end of the elongate body, which is operable to receive an externally threaded portion of a hole saw arbour.

20. A hole saw holder according to claim 16, wherein the internally threaded portion of the bore has the same major diameter as the externally threaded portion of the elongate body.

21. A hole saw holder according to claim 16, wherein the second end of the elongate body has an end face which includes one or more holes or slots for receiving an engageable pin or other retaining member of an arbour that is coupled to the coupling formation and which has such pins or other retaining members for retaining hole saws on the arbour.

22. A kit comprising:
(i) a hole saw holder comprising an elongate body having a first end and a second end, wherein the first end has an external thread of sufficient length to receive a plurality of hole saws, and a support formation at the end of the external thread for supporting one or more hole saws received by the external thread; and
(ii) a hole saw having a base plate with a central internally threaded hole therein, wherein the internally threaded hole in the base plate is suitable for threading onto the external thread of the hole saw holder.

23. A kit according to claim 22, further comprising a plurality of said hole saws of different diameters.

24. A kit according to claim 22, wherein the hole saw holder comprises a central axial drill bit receiving bore which extends throughout the length of the elongate body.

25. A kit according to claim 24, wherein the external thread of the hole saw holder is at least 1 cm long.

26. A kit according to claim 24, wherein the second end of the elongate body comprises a coupling formation for coupling the hole saw holder to an arbour.

27. A kit according to claim 26, wherein the coupling formation comprises an internally threaded portion of the bore at the second end of the elongate body, which is operable to receive an externally threaded portion of a hole saw arbour.

28. A kit according to claim 24, wherein the internally threaded portion of the bore has the same major diameter as the externally threaded portion of the elongate body.

29. A kit according to claim 24, wherein the second end of the elongate body has an end face which includes one or more holes or slots for receiving an engageable pin or other retaining member of an arbour that is coupled to the coupling formation and which has such pins or other retaining members for retaining hole saws on the arbour.

30. A kit according to claim 22, further comprising an arbour having a first end and a second end, wherein the first end comprises a drill bit retaining member with an external thread for receiving a hole saw and the second end comprises a formation for attachment to a drill chuck, wherein the hole way has a central axial drill bit receiving bore which extends throughout the length of the elongate body and the dimensions of the external thread of the arbour are such that the arbour can be threaded into the internally threaded portion of the bore of the hole saw holder.

31. A kit according to claim 22, further comprising a pilot drill bit, the length of which is selected such that, when the pilot drill bit is fitted into the drill bit retaining member, the hole saw holder is screwed onto the external thread of the arbour, and a hole saw is screwed onto the external thread of the hole saw holder, the pilot drill bit extends into but not beyond the hole saw.

32. A kit comprising:
(i) a hole saw holder comprising an elongate body having a first end and a second end, wherein the first end has an external thread of sufficient length to receive a plurality of hole saws, a support formation at the end of the external thread for supporting one or more hole saws received by the external thread, a central axial drill bit receiving bore which extends throughout the length of the elongate body, and a coupling formation at the second end for coupling the hole saw holder to an arbour; and
(ii) (ii) an arbour having a first end and a second end, wherein the first end comprises an drill bit retaining member with an external thread for receiving a hole saw and the second end comprises a formation for attachment to a drill chuck, wherein the dimensions of the external thread of the arbour are such that the arbour can be threaded into the internally threaded portion of the bore of the hole saw holder.
